(19) United States
(12) Patent Application Publication
(10) Pub. No.: US 2009/0232564 A1
(43) Pub. Date: Sep. 17, 2009

(54) METHOD OF PRODUCING OA APPARATUS ROLLER AND OA APPARATUS ROLLER

(75) Inventors: Yoshimasa Suzuki, Osaka (JP); Masahiro Habuka, Osaka (JP); Yoshitaka Ikeda, Osaka (JP)

Correspondence Address: OSHA LIANG L.L.P., TWO HOUSTON CENTER, 909 FANNIN, SUITE 3500, HOUSTON, TX, 77010, US

(73) Assignee: Sumitomo Electric Fine Polymer, Inc., Osaka (JP)

(21) Appl. No.: 12/335,229

(22) Filed: Dec. 15, 2008

(30) Foreign Application Priority Data
Dec. 27, 2007 (JP) 2007-336959
Dec. 27, 2007 (JP) 2007-336962

(51) Int. Cl. G03G 15/08; B05D 1/36; B28B 1/24

(52) U.S. Cl. 399/286; 427/409; 264/255

(57) ABSTRACT

The invention offers a method of producing an OA apparatus roller that can increase the thermal conductivity of the surface layer composed of a fluororesin layer by decreasing its thickness, that has an excellent parting ability, that can prevent the rubber layer from deteriorating, and that is free from foreign matters adhering onto the inner surface of a hollow cylindrical mold even when the hollow cylindrical mold is used. The invention also offers an OA apparatus roller produced by the foregoing method. The method of producing an OA apparatus roller is provided with a step of forming an elastic layer and a surface layer in this order on a core metal. In this method, the surface layer is formed by using a fluororesin dispersion and the fluororesin dispersion contains a surfactant, a film-thickening agent, and a viscosity-increasing agent with a total content of 1.0 to 5.0 wt %.

### BACKGROUND OF THE INVENTION

1. Field of the Invention

The present invention relates to a method of producing an OA apparatus roller to be used, for example, as a fixing roller and a pressing roller of a fixing section of an OA apparatus, such as a copier, and a developing roller and a charging roller of a developing section of the foregoing OA apparatus. The present invention also relates to an OA apparatus roller produced by the foregoing method.

2. Description of the Related Art

Generally, this type of roller has a structure in which a rubber layer as an elastic layer is formed on the outer circumference of a core metal and a surface layer is formed on the elastic layer. The surface layer is composed of a fluororesin layer made of tetrafluoroethylene-perfluoroalkylvinylether copolymer (PFA), polytetrafluoroethylene (PTFE), fluorinated ethylene-propylene copolymer (FEP), or the like, so that a parting ability is obtained.

In recent years, the market has been requiring to develop an OA apparatus roller that can meet the requirement of giving full-color performance and high-speed operation to a copier or the like. To meet this requirement, it is desirable that in the roller, the layers formed on the core metal be softer than ever before. In other words, the roller is required to have a thinner surface layer so that the layers on the core metal can be softer. However, conventional methods of producing an OA apparatus roller have been unable to satisfactorily meet these requirements as described below.

For example, in the powder-coating method in which a fluororesin layer is formed by using powder of fluororesin, one layer cannot be formed if the thickness is less than 20 μm. Therefore, it cannot be said that this method satisfactorily meets the requirement of the speed increase.

On the other hand, in the method of forming a surface layer by using a fluororesin tube (see Patent literature 1), as the tube decreases its thickness, the handling for slipping the tube over the underlying object becomes difficult. This method also has another problem that the tube is high in cost. Furthermore, this method has the below-described problem. To form a laminated structure, it is necessary either to produce, for example, a two-layer tube or to produce two or more single-layer tubes to unify them after they are placed in layers. However, it is extremely difficult to produce a two-layer tube having a thickness of 30 μm or less. On the other hand, to obtain a roller having two or more tubes placed in layers, it is necessary to unify the tubes by baking them at a temperature as high as 400° C. or more. In this case, however, the rubber layer, which is inferior in heat-resisting property to the fluororesin, deteriorates, rendering this method impracticable.

On the other hand, to form a thin fluororesin layer, another method is known in which a fluororesin dispersion is used to form the layer.

One of the methods of forming a fluororesin layer using the fluororesin dispersion is to form a fluororesin layer by applying the fluororesin dispersion on the outer circumferential surface of the rubber layer and then by performing a baking operation. However, to obtain a surface layer having a good property by using this method, it is necessary to perform the baking sufficiently for a long time. As with the foregoing method of using tubes, when the baking is performed for a long time, because the baking must be performed at a temperature as high as 400° C. or more, the rubber layer, which is inferior in heat-resisting property to the fluororesin, deteriorates, thereby causing a problem.

Yet another method of producing the roller is known, which also forms a fluororesin layer by using the fluororesin dispersion. According to this method of producing an OA apparatus roller, the surface layer is formed without adversely affecting the rubber layer by the heat at the time the fluororesin is baked. This method is explained below. First, a fluororesin dispersion is applied onto the inner circumferential surface of the hollow cylindrical mold. A fluororesin layer is formed by performing the baking. Next, a core metal is inserted into the hollow space of the hollow cylindrical mold. The material for forming the rubber layer is injected into the space between the fluororesin layer and the core metal. After the vulcanization is performed, the product is drawn out of the hollow cylindrical mold to complete the production. According to this method, the rubber layer is not affected by the baking temperature. Consequently, the fluororesin can be completely baked and the rubber layer can be prevented from deteriorating.

In the case of the above-described method, however, it has been found that after the product is drawn out of the hollow cylindrical mold (hereinafter also referred to as releasing from the mold), the surfactant, film-thickening agent, and viscosity-increasing agent contained in the coating material (a fluororesin dispersion) remain on the inner circumferential surface of the hollow cylindrical mold as the decomposition products produced at the time of the baking. Consequently, when the mold is used repeatedly, the parting ability of the inner circumferential surface of the hollow cylindrical mold is decreased. Finally, the releasing from the mold becomes impossible. In addition, it has also been found that the cleaning operation of the hollow cylindrical mold for removing these residual substances to recover the parting ability is extremely cumbersome, causing the problem that this method is unsuitable for mass production.

As described above, conventional methods of producing an OA apparatus roller have difficulty in forming a thin fluororesin layer. As a result, it has been difficult to improve the softness of the surface layer to meet the requirement of full-color performance and high-speed operation.

Patent literature 1: the published Japanese patent application Tokukai 2004-276290.

### SUMMARY OF THE INVENTION

An object of the present invention is to offer a method of producing an OA apparatus roller that can improve the softness of the layers on the core metal by decreasing the thickness of the surface layer composed of a fluororesin layer, that has an excellent parting ability, that can prevent a rubber layer from deteriorating, and that is free from residual substances adhering onto the inner surface of a hollow cylindrical mold even when the hollow cylindrical mold is used. Another object of the present invention is to offer an OA apparatus roller produced by the foregoing method.

A fluororesin dispersion usually has a surfactant content of 15 to 20 wt % or so to have a dispersion stability of the fluororesin powder and to achieve a good wettability with the object to which it is to be applied. To increase the film-forming ability, it also has a film-thickening-agent content of 10 to 15 wt % or so and a viscosity-increasing-agent content of 10 to 15 wt % or so.

The present inventor has found that because of the presence of the foregoing ingredients, when the baking is incomplete, the surfactant, film-thickening agent, and viscosity-increasing agent remain in the fluororesin layer after the baking, so that the parting ability of the fluororesin layer is decreased.

In view of the above finding, the present inventor has diligently studied and has found that in the case where the thickness of the film is sufficiently reduced, even when the amounts of the surfactant, film-thickening agent, and viscosity-increasing agent are decreased, the film can be formed. It has also been found that when the amounts of these ingredients are decreased, it is possible to eliminate the remaining of these ingredients without performing a long-time complete baking, thereby preventing the parting ability from decreasing. In other words, the present inventor has found that the above-described method enables the formation of a fluororesin layer that combines a reduced film thickness and a parting ability.

According to the foregoing method in which not only is the film thickness decreased but also the amounts of the surfactant, film-thickening agent, and viscosity-increasing agent contained in the fluororesin dispersion are decreased, the baking can be performed in a short time. As a result, the present inventor has found that this method can produce an excellent OA apparatus roller that is almost free form the influence of the deterioration of the rubber layer caused by the baking temperature.

Furthermore, the present inventor has found that in the method of forming a fluororesin layer by applying the fluororesin dispersion onto the inner surface of a hollow cylindrical mold and then by performing a baking operation, the residual substances on the inner surface of the hollow cylindrical mold are decomposition products of the surfactant, film-thickening agent, and viscosity-increasing agent as described above.

It has been found that by significantly reducing the amounts of the surfactant, film-thickening agent, and viscosity-increasing agent, the adhering of the decomposition products can be prevented from occurring. Consequently, the present inventor has found that in the method of forming a fluororesin layer by using a hollow cylindrical mold, by using a fluororesin dispersion containing significantly reduced amounts of the surfactant, film-thickening agent, and viscosity-increasing agent, an OA apparatus roller can be produced that enables the performing of a sufficient baking without deteriorating the rubber layer at all and that is suitable for mass production.

Because a roller having a thin surface layer can be realized as described above, the present invention can offer an OA apparatus roller that can secure the good softness of the layers on the core metal and that can meet the requirement of full-color performance and high-speed operation, which particularly demand the softness of the layers on the core metal. In addition, the present invention can offer an OA apparatus roller that can have high durability, because the roller has good parting ability and is free from the influence of the deterioration of the rubber layer.

In addition, because a thin film can be formed, even when a plurality of layers are formed, good softness can be secured. By giving different properties to the individual layers while satisfying the requirement of full-color performance and high-speed operation, the present invention can offer an OA apparatus roller that has multiple properties, which has been difficult to achieve with a single layer.

By forming the surface layer using a plurality of layers, the defect caused by pinholes is decreased and the manufacturing yield is increased. As a result, the present invention can offer an OA apparatus roller low in cost.

The study of the total amount of the surfactant, film-thickening agent, and viscosity-increasing agent contained in the fluororesin dispersion has revealed that a content of 1.0 to 5 wt % is desirable.

If the content is less than 1.0 wt %, the fluororesin dispersion decreases its dispersion stability and has poor wettability with the object to which it is to be applied, so that it becomes difficult to form the film.

In contrast, if the content is more than 5 wt %, unless the baking is performed for a sufficiently long time, decomposition products of the surfactant, film-thickening agent, and viscosity-increasing agent remain in the baked fluororesin layer, exercising an adverse effect on the parting ability. Moreover, when the film is formed on the inner surface of the hollow cylindrical mold, residual substances may adhere to the inner surface of the hollow cylindrical mold.

In view of the above circumstances, the present invention offers a method of producing an OA apparatus roller. The method is provided with a step of forming an elastic layer and a surface layer in this order on a core metal. The method has the following features:
(a) the surface layer is formed by using a fluororesin dispersion; and
(b) the fluororesin dispersion contains a surfactant, a film-thickening agent, and a viscosity-increasing agent with a total content of 1.0 to 5.0 wt %.

According to the present invention, the surface layer composed of a fluororesin layer can have a decreased thickness to increase the thermal conductivity as described above. In addition, the method not only can give the OA apparatus roller an excellent parting ability but also can prevent the rubber layer from deteriorating. Even when a hollow cylindrical mold is used, no residual substances adhere to the inner surface of the hollow cylindrical mold.

When the multiple fluororesin layers are laminated, it is desirable that the surface of the previously formed fluororesin layer be treated through the plasma treatment, the electrical-discharge machining, the chemical etching, or the like to increase the wettability before applying the fluororesin dispersion. This process enables the formation of a thin smooth film having a better bonding property.

When a hollow cylindrical mold is used, it is also desirable that the surface of the fluororesin layer be treated through the plasma treatment or the like to increase the wettability of the fluororesin layer at the time the bonding layer is formed.

The elastic layer is not particularly limited; various types of elastic layer may be employed. For example, various types of rubber may be used, such as solid rubber or spongelike rubber (balloon rubber).

It is desirable that the core metal of the OA apparatus roller in the present invention be composed of aluminum, iron, carbon steel, stainless steel, or the like.

According to the present invention, an intermediate layer may be provided between the elastic layer and the surface layer. The providing of an intermediate layer having a different property enables the offering of an OA apparatus roller that can meet the required specification of various users in addition to the exercising of the above-described effect. More specifically, an intermediate layer made of highly heat-conductive rubber or electrically conductive rubber may be used. The intermediate layer may also be made of adhesive.

As described above, it is desirable that the total content of the surfactant, film-thickening agent, and viscosity-increasing agent in the fluororesin dispersion be at most 5.0 wt %. More specifically, the present inventor has found that it is desirable that the content of each of the film-thickening agent and the viscosity-increasing agent be at most 1 wt % and that it is more desirable that practically no film-thickening and viscosity-increasing agents be contained in the dispersion.

Consequently, according to the present invention, the fluororesin dispersion may have a film-thickening-agent content of at most 1 wt % and a viscosity-increasing-agent content of at most 1 wt %.

According to the present invention, the fluororesin dispersion may contain practically no film-thickening and viscosity-increasing agents.

According to the present invention, the fluororesin dispersion for forming the surface layer may have a fluororesin constituent that is composed of at least one member selected from the group consisting of PFA, PTFE, and FEP.

As described above, when PFA, PTFE, or FEP is used as the fluororesin, the surface layer becomes far excellent in heat-resisting property and parting ability.

According to the present invention, the surface layer may be composed of a single fluororesin layer having a thickness of 3 to 15 μm.

As described above, when the surface layer is composed of a fluororesin layer having a thickness of 3 to 15 μm, its softness can be further increased while the excellent properties as the surface layer are being secured. Consequently, the present invention can offer an OA apparatus roller that can satisfy the requirement of higher-level full-color performance and high-speed operation. In addition, it is more desirable that the surface layer have a thickness of at most 12 μm.

According to the present invention, the method of producing an OA apparatus roller may have the following features:

(a) the surface layer is composed of a plurality of fluororesin layers;

(b) each of the fluororesin layers has a thickness of 3 to 15 μm; and

(c) the surface layer has a total thickness of 6 to 30 μm.

As described above, when the surface layer has a total thickness of at least 6 μm, a plurality of layers can be formed, enabling the surface layer to have many excellent properties. When the surface layer has a total thickness of at most 30 μm, the surface layer can not only maintain its softness but also secure the thermal conduction, enabling the roller to meet the requirement of full-color performance and high-speed operation. Moreover, when each of the layers has a thickness as thin as 3 to 15 μm, the total thickness of the surface layer can fall within the foregoing range while enabling the achieving of many properties by forming a plurality of layers.

As a concrete method of achieving many properties by forming a plurality of layers, it is desirable that the outermost layer be a fluororesin layer containing no filler that can impart various properties and that at least one layer other than the outermost layer be a layer containing filler that can impart various properties.

When this desirable structure is employed, the surface layer can obtain improved properties in electrical conductivity, thermal conductivity, wear resistance, strength, and so on. Therefore, the present invention can offer an OA apparatus roller that has various excellent properties and that can obtain higher performance.

The types of filler having electrical conductivity include a metallic powder, such as a Cu powder and an Al powder, and an ion salt. The types of filler having thermal conductivity and wear resistance include SiC, TiO₂, and BN.

In addition, it is desirable that the multiple fluororesin layers have a total thickness of at most 20 μm, more desirably at most 15 μm, and most desirably at most 12 μm.

According to the present invention, the method of producing an OA apparatus roller may have the following features:
(a) the surface layer is formed by applying the fluororesin dispersion onto the inner surface of a hollow cylindrical mold and then by performing a baking operation;
(b) the elastic layer is formed by inserting the core metal into the hollow space of the hollow cylindrical mold and then by injecting a material for forming the elastic layer into the space between the surface layer and the core metal; and
(c) the OA apparatus roller in which the elastic layer and the surface layer are formed on the core metal is drawn out of the hollow cylindrical mold.

When the OA apparatus roller is produced as described above, because the surface layer is formed without affecting the elastic layer by the baking temperature, the deterioration of the elastic layer due to the baking can be eliminated. Because the total content of the surfactant, film-thickening agent, and viscosity-increasing agent in the fluororesin dispersion is specified, no residual substances adhere to the inner surface of the hollow cylindrical mold. Consequently, the hollow cylindrical mold can be used repeatedly without performing a cleaning operation, thereby enabling the mass production of the OA apparatus roller having a thin surface layer.

According to one aspect of the present invention, the present invention offers an OA apparatus roller produced through the method of the present invention for producing an OA apparatus roller.

The OA apparatus roller to be offered is produced through the method of the present invention for producing an OA apparatus roller. Consequently, the OA apparatus roller not only can meet the requirement for full-color performance and high-speed operation but also can obtain a high picture quality. The present invention can offer an OA apparatus roller that has various excellent properties and that is suitable for mass production.

The present invention can offer a method of producing an OA apparatus roller that can improve the softness of the layers on the core metal by decreasing the thickness of the surface layer composed of a fluororesin layer, that has an excellent parting ability, that can prevent the rubber layer from deteriorating, and that is free from residual substances adhering onto the inner surface of a hollow cylindrical mold even when the hollow cylindrical mold is used. The present invention can also offer an OA apparatus roller produced by the foregoing method.

### BRIEF DESCRIPTION OF THE DRAWINGS

FIGS. 1A and 1B are diagrams schematically showing the OA apparatus roller in an embodiment of the present invention, in which FIG. 1A is a diagram showing a cross section perpendicular to the axis and FIG. 1B is a perspective view.

FIG. 2 is a perspective view schematically showing the method of an embodiment of the present invention for producing an OA apparatus roller.

In the foregoing figures, the individual signs represent the following members: 1: OA apparatus roller; 2: Core metal; 3: Elastic layer; 4: Intermediate layer; 5: Surface layer; 5a: First surface layer (outer layer); 5b: Second surface layer (inner layer); and 6: Hollow cylindrical mold.

### DETAILED DESCRIPTION OF THE PREFERRED EMBODIMENT

The present invention is concretely explained below. The present invention is not limited to the following embodiments. The following embodiments can be modified variously not only within the scope of the present invention but also within the equivalent scope of the present invention.

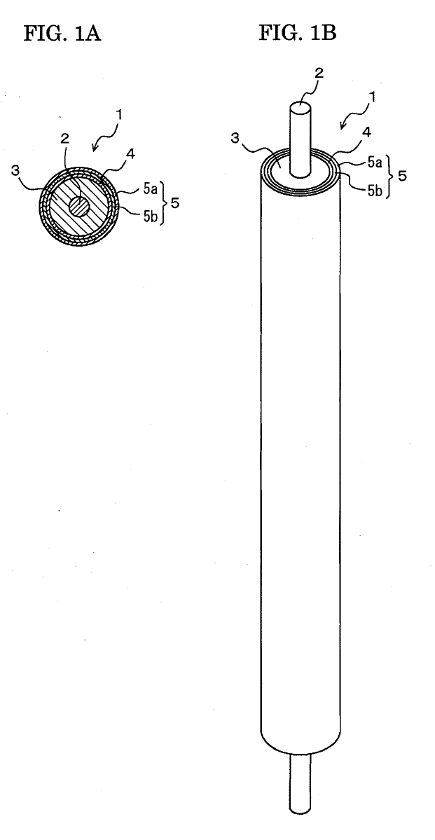

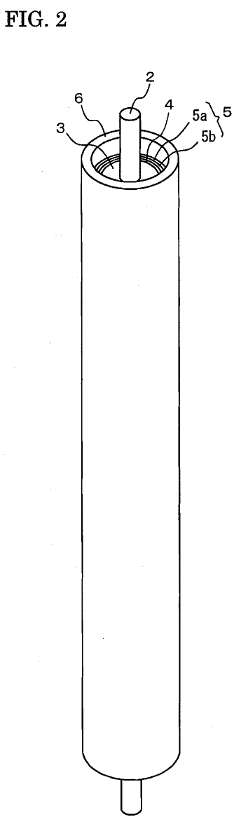

Embodiments of the present invention are explained below based on FIGS. 1A, 1B, and 2. FIGS. 1A and 1B are diagrams schematically showing the OA apparatus roller produced through the method of an embodiment of the present invention for producing an OA apparatus roller. FIG. 1A is a diagram showing a cross section perpendicular to the axis of the roller and FIG. 1B is a perspective view. FIG. 2 is a perspective view schematically showing the method of an embodiment of the present invention for producing an OA apparatus roller.

An OA apparatus roller 1 is provided with on a core metal 2 an elastic layer 3, an intermediate layer 4, and a surface layer 5 formed in this order from the interior. The surface layer 5 is composed of a first surface layer (an outer layer) 5a and a second surface layer (an inner layer) 5b. The OA apparatus roller 1 is produced by using a hollow cylindrical mold 6 and by forming the first surface layer 5a, the second surface layer 5b, the intermediate layer 4, and the elastic layer 3 in this order. The production method is explained below more specifically. The surface layer 5 may be composed of either a single layer or multiple layers having the same composition.

(a) A fluororesin dispersion containing a surfactant, a film-thickening agent, and a viscosity-increasing agent with a total content of 1.0 to 5.0 wt % is applied (for example, by flow coating) onto the inner circumferential surface of the hollow cylindrical mold 6. The hollow cylindrical mold is revolved around its own axis to perform the drying. The fluororesin is baked completely at a temperature as high as at least its melting point and at most 400° C. to form the first surface layer (the outer layer) 5a, which is a fluororesin layer having a thickness of 3 to 10 μm.

The types of surfactant include an ionic surfactant, such as a cationic surfactant and an anionic surfactant, and a nonionic surfactant. More specifically, the types of ionic surfactant include an anionic surfactant having a carboxylic acid group, sulfonic acid group, phosphoric acid group, or the like as a hydrophilic group and a cationic surfactant having tetraalkylammonium or the like as a hydrophilic group. The types of nonionic surfactant include a low-molecule surfactant, such as alkylglucoside, and a high-molecule surfactant, such as polyethylene glycol.

(b) To improve the bonding property, wettability, and hydrophilic property, the inner circumferential surface of the first surface layer 5a is treated, for example, by using plasma.

(c) A fluororesin dispersion that contains considerably reduced amounts of the surfactant, film-thickening agent, and viscosity-increasing agent and that further contains filler is applied (for example, by flow coating) onto the inner circumferential surface of the first surface layer 5a. After the drying operation is performed, the fluororesin is baked completely at a temperature as high as at least its melting point and at most 400° C. to form the second surface layer (the inner layer) 5b, which is a fluororesin layer having a thickness of 3 to 10 μm.

(d) The inner surface of the second surface layer 5b is treated, for example, by using plasma. When needed, a bonding layer is formed at the inner surface of the second surface layer 5b.

(e) In the case where an intermediate layer is formed, rubber having various properties is applied (for example, by flow coating) onto either the inner circumferential surface of the second surface layer 5b or the inner surface of the bonding layer. The hollow cylindrical mold 6 is revolved around its own axis to perform the drying. Thus, the intermediate layer 4 having a thickness of 50 to 150 μm is formed.

(f) The core metal 2 is inserted into the hollow space of the hollow cylindrical mold so as to be coaxial with the hollow cylindrical mold. Foamable rubber is injected into the space between the intermediate layer 4 and the core metal 2. Then, the vulcanization is performed. Thus, the elastic layer 3 having a thickness of 1.5 to 3.5 mm is formed.

(g) Subsequently, the OA apparatus roller 1 is released from the hollow cylindrical mold 6.

When a surface layer 5 having multiple layers is formed, the number of layers is not limited to the foregoing two layers. However, it is desirable that the outermost layer be a fluororesin layer containing no filler. It is desirable that at least one layer other than the outermost layer be a fluororesin layer containing filler. When this structure is employed, because the outermost layer in the multiple fluororesin layers forming the surface layer is a fluororesin layer containing no filler, this structure can secure better softness and parting ability. In addition, because at least one layer other than the outermost layer is a fluororesin layer containing filler, this structure can impart the surface layer improved properties in electrical conductivity, thermal conductivity, wear resistance, strength, and so on. Therefore, the present invention can offer an OA apparatus roller that is excellent in various properties and that can further improve the picture quality.

The types of filler having electrical conductivity include a metallic powder, such as a Cu powder and an Al powder, and an ion salt. The types of filler having thermal conductivity and wear resistance include SiC, TiO₂, and BN.

When the intermediate layer 4 is further provided between the elastic layer 3 and the surface layer 5, the roller can not only be augmented with the above-described effects but also meet the specification required by various users.

In this embodiment, as described above, an explanation is given to the method of producing an OA apparatus roller by using the hollow cylindrical mold 6 and to the OA apparatus roller produced by the foregoing method. However, because the present invention enables a short-time baking, an OA apparatus roller having a thin surface layer can also be produced without using the hollow cylindrical mold 6 through the following method. First, a fluororesin dispersion is applied onto the surface of the rubber layer or the intermediate layer. Then, the baking is performed. This method can also suppress the rubber layer from deteriorating. The OA apparatus roller of the present invention can be more suitably used as a pressing roller and a fixing device roller.

### Example 1

A concrete explanation is given below based on Example 1.

### (a) Formation of the Surface Layer (a Single-Layer Type)

A PFA dispersion (EMX-047, made by Du Pont Co.), having a PFA content of 60 vol % and a surfactant content of at most 5 wt % and at least 1 wt %, was applied onto the inner surface of the hollow cylindrical mold 6 that was made of stainless steel (SUS) and that had an inner diameter of 18 mm and a length of 257 mm. The hollow cylindrical mold 6 was revolved around its own axis for 10 minutes at room temperature to perform the drying. The PFA was baked completely by heating it at 400° C. for 30 minutes. Thus, the surface layer 5 having a thickness of 8 μm was formed on the inner circumferential surface of the hollow cylindrical mold 6.

### (b) Formation of the Bonding Layer on the Inner Circumferential Surface of the Surface Layer

After the inner surface of the surface layer 5 was plasma-treated, Si-rubber-use adhesive (DY39-051, made by Dow Corning Toray Co.) was applied (by flow coating) onto the inner circumferential surface of the surface layer 5. The hollow cylindrical mold 6 was revolved around its own axis for 15 minutes at 120° C. to perform the drying. Thus, the bonding layer (not shown) having a thickness of 1 μm or less was formed.

### (c) Formation of the Bonding Layer on the Surface of the Core Metal

Si-rubber-use adhesive (DY39-051, made by Dow Corning Toray Co.) was applied onto the surface of the core metal 2 that was made of iron and that had a diameter of 11 mm. Drying was performed for 15 minutes at 120° C. Thus, the bonding layer (not shown) having a thickness of 1 μm or less was formed.

### (d) Formation of the Elastic Layer

(d1) Injection into the Mold

The core metal 2 whose surface was provided with the bonding layer was inserted into the hollow space of the hollow cylindrical mold 6. Foamable Si rubber (balloon rubber) (X34-2061-28L, made by Shin-Etsu Chemical Co.) was injected into the space between the surface layer 5 and the core metal 2.

(d2) Primary Vulcanization

The primary vulcanization of the foregoing foamable Si rubber (balloon rubber) was performed at 160° C. for 15 minutes including the temperature-rising period. Thus, the elastic layer 3 having a thickness of 3.5 mm was formed.

(d3) Releasing from the Mold

The OA apparatus roller 1 was released from the hollow cylindrical mold 6. No residual substances were recognized on the inner surface of the hollow cylindrical mold 6. It was possible to form the surface layer 5 through complete baking. The surface layer 5 had a thickness of 8 μm.

(d4) Secondary Vulcanization

After being released from the mold, the OA apparatus roller 1 was subjected to a secondary vulcanization at 250° C. for 30 minutes including the temperature-rising period.

### (e) Cutting and Finishing

The portions in the vicinity of both ends of the formed individual layers were removed by cutting. Then, cleaning and visual inspection were carried out. Thus, the production of the OA apparatus roller 1 was completed.

In this example, the PFA dispersion had a surfactant content of at most 5 wt % and at least 1 wt % without containing a film-thickening agent and a viscosity-increasing agent. Consequently, there were no residual substances adhering to the hollow cylindrical mold.

In addition, the thickness of the surface layer was decreased to a thickness as thin as 8 μm and a fluororesin layer containing no filler was used as the surface layer. As a result, it was possible to produce an OA apparatus roller that had better softness in the layers on the core metal, that had excellent parting ability, and that was free from the deterioration of the elastic layer because the elastic layer was not affected by the baking temperature.

The produced OA apparatus roller was evaluated as a pressing roller. The result showed that the roller had an intended performance and the bonding property between the individual layers had no problem. It was confirmed that by using this roller, a high picture quality can be obtained and the requirement for full-color performance and high-speed operation can be satisfied. It was also confirmed that the roller has an excellent durability.

### Example 2

Example 2 is an example in which the surface layer is composed of two layers having the same composition. Example 2 is the same as Example 1, except for the constitution and thickness of the surface layer. Consequently, as for the production process for the OA apparatus roller in Example 2, only the formation of the surface layer is described below.

Formation of the Surface Layer

(a) Formation of the First Surface Layer (the Outer Layer)

A PFA dispersion (EMX-047, made by Du Pont Co.), having a PFA content of 60 vol % and a surfactant content of at most 5 wt % and at least 1 wt %, was applied onto the inner surface of the hollow cylindrical mold 6 that was made of stainless steel and that had an inner diameter of 18 mm and a length of 257 mm. The hollow cylindrical mold 6 was revolved around its own axis for 10 minutes at room temperature to perform the drying. The PFA was baked completely by heating it at 400° C. for 30 minutes. Thus, the first surface layer 5a having a thickness of 6 μm was formed on the inner circumferential surface of the hollow cylindrical mold 6.

(b) Formation of the Second Surface Layer (the Inner Layer)

After the inner surface of the first surface layer 5a was plasma-treated, the above-described PFA dispersion (EMX-047, made by Du Pont Co.) was applied onto the inner surface of the first surface layer 5a. The hollow cylindrical mold 6 was revolved around its own axis for 10 minutes at room temperature to perform the drying. The PFA was baked completely by heating it at 400° C. for 30 minutes. Thus, the second surface layer 5b having a thickness of 6 μm was formed on the inner circumferential surface of the first surface layer 5a.

In this example, also, the PFA dispersion had a surfactant content of at most 5 wt % and at least 1 wt % without containing a film-thickening agent and a viscosity-increasing agent. Consequently, as with Example 1, it was confirmed that there were no residual substances adhering to the hollow cylindrical mold.

In addition, in this example, the thickness of each of the first and second surface layers was decreased to a thickness as thin as 6 μm, so that even though the surface layer had a double-layer structure, the total thickness of the surface layer was decreased to a thickness as thin as 12 μm. As a result, it was possible to produce an OA apparatus roller that had good softness in the layers on the core metal, that had excellent parting ability, and that was free from the deterioration of the elastic layer because the elastic layer was not affected by the baking temperature.

The produced OA apparatus roller was evaluated as a pressing roller. The result showed that the roller had an intended performance. As with Example 1, it was confirmed that by using this roller, a high picture quality can be obtained and the requirement for full-color performance and high-speed operation can be satisfied. It was also confirmed that the roller has an excellent durability.

### Example 3

Example 3 is an example in which an intermediate layer is provided and proper electrical conductivity is given to the surface layer, intermediate layer, and elastic layer. More specifically, the resin for forming the surface layer is electrically conductive PFA, the surface layer contains carbon as a filler having electrical conductivity, and the intermediate layer and elastic layer are composed of Si rubber having electrical conductivity, so that electrical conductivity is given to these layers as a whole. A detailed explanation is given below.

### (a) Formation of the Surface Layer (a Single-Layer Type)

A PFA dispersion (EMX-054-3, made by Du Pont Co.), containing 60-vol % electrically conductive PFA, a filler composed of carbon powder with a content of 2 wt % in the baked film (the surface layer), and a surfactant with a content of at most 5 wt % and at least 1 wt %, was applied onto the inner surface of the hollow cylindrical mold 6 that was made of stainless steel and that had an inner diameter of 12 mm and a length of 257 mm. The hollow cylindrical mold 6 was revolved around its own axis for 10 minutes at room temperature to perform the drying. The PFA was baked completely by heating it at 400° C. for 30 minutes. Thus, the surface layer 5 having a thickness of 8 μm was formed on the inner circumferential surface of the hollow cylindrical mold 6.

### (b) Formation of the Intermediate Layer

After the inner surface of the surface layer 5 was plasma-treated, one-liquid-type electrically conductive Si rubber (XE16-B7702, made by Momentive Co.) was applied (by flow coating) onto the inner circumferential surface of the surface layer 5. The hollow cylindrical mold 6 was revolved around its own axis for 15 minutes at 120° C. to perform the drying. Thus, the intermediate layer 4 having a thickness of 4 μm was formed.

### (c) Formation of the Bonding Layer on the Surface of the Core Metal

Si-rubber-use adhesive (DY39-051, made by Dow Corning Toray Co.) was applied onto the surface of the core metal 2 that was made of iron and that had a diameter of 6 mm. Then, drying was performed at 120° C. for 15 minutes. Thus, the bonding layer (not shown) having a thickness of 1 μm or less was formed.

### (d) Formation of the Elastic Layer

(d1) Injection into the Mold

The core metal 2 whose surface was provided with the bonding layer was inserted into the hollow space of the hollow cylindrical mold 6. Electrically conductive Si rubber (X34-2869, made by Shin-Etsu Chemical Co.) was injected into the space between the surface layer 5 and the core metal 2.

(d2) Primary Vulcanization

The primary vulcanization of the foregoing conductive Si rubber was performed at 160° C. for 15 minutes including the temperature-rising period. Thus, the elastic layer 3 having a thickness of 3 mm was formed.

(d3) Releasing from the Mold

The OA apparatus roller 1 was released from the hollow cylindrical mold 6. No decomposition products were recognized on the inner surface of the hollow cylindrical mold 6. It was possible to form the surface layer 5 through complete baking. The surface layer 5 had a thickness of 8 μm.

(d4) Secondary Vulcanization

After being released from the mold, the OA apparatus roller 1 was subjected to a secondary vulcanization at 250° C. for 30 minutes including the temperature-rising period.

### (e) Cutting and Finishing

The portions in the vicinity of both ends of the formed individual layers were removed by cutting. Then, cleaning and visual inspection were carried out. Thus, the production of the OA apparatus roller 1 was completed.

In this example, also, the PFA dispersion had a surfactant content of at most 5 wt % and at least 1 wt % without containing a film-thickening agent and a viscosity-increasing agent. Consequently, as with Example 1, it was confirmed that there were no residual substances adhering to the hollow cylindrical mold.

In addition, the thickness of the surface layer was decreased to a thickness as thin as 8 μm. As a result, it was possible to produce an OA apparatus roller that had good softness in the layers on the core metal, that had excellent parting ability, and that was free from the deterioration of the elastic layer.

Furthermore, the surface layer, intermediate layer, and elastic layer were all composed of electrically conductive material. The bonding layer formed on the surface of the core metal had a thickness as extremely thin as 1 μm or less so as to have electrical conductivity. As a result, it was possible to produce an OA apparatus roller in which all layers had electrical conductivity.

The produced OA apparatus roller was evaluated as a charging roller. The result showed that the roller had a uniform charging function. It was confirmed that by using this roller, a high picture quality can be obtained and the requirement for full-color performance and high-speed operation can be satisfied. It was also confirmed that the roller has an excellent durability.

### Example 4

Example 4 is an example in which the durability and thermal conductivity are improved. More specifically, the surface layer is composed of two layers, in which the second surface layer contains, as the filler, an SiC filler that is effective in improving the wear resistance and thermal conductivity. As a result, in this example, the durability and thermal conductivity are improved. Example 4 is the same as Example 2, except for the material of the surface layer, the inner diameter of the hollow cylindrical mold used, and the thickness of the elastic layer. Consequently, as for the production process for the OA apparatus roller in Example 4, only the formations of the surface and elastic layers are described below.

### (a) Formation of the Surface Layer

(a1) Formation of the First Surface Layer (the Outer Layer)

A PFA dispersion (EMX-047, made by Du Pont Co.), containing 60-vol % electrically conductive PFA and having a surfactant content of at most 5 wt % and at least 1 wt %, was applied onto the inner surface of the hollow cylindrical mold 6 that was made of stainless steel and that had an inner diameter of 14 mm and a length of 257 mm. The hollow cylindrical mold 6 was revolved around its own axis for 10 minutes at room temperature to perform the drying. The PFA was baked completely by heating it at 400° C. for 30 minutes. Thus, the first surface layer 5a having a thickness of 6 μm was formed on the inner circumferential surface of the hollow cylindrical mold 6.

(a2) Formation of the Second Surface Layer (the Inner Layer)

After the inner surface of the first surface layer 5a was plasma-treated, a PFA dispersion (EMX-041-2, made by Du Pont Co.), containing 60-vol % electrically conductive PFA, an SiC filler with a content of 14.5 vol % in the baked film (the second surface layer), and a surfactant with a content of at most 5 wt % and at least 1 wt %, was applied onto the inner surface of the first surface layer 5a. The hollow cylindrical mold 6 was revolved around its own axis for 10 minutes at room temperature to perform the drying. The PFA was baked completely by heating it at 400° C. for 30 minutes. Thus, the second surface layer 5b having a thickness of 6 μm was formed on the inner circumferential surface of the first surface layer 5a.

### (b) Formation of the Elastic Layer

As with the formation of the elastic layer in Example 1, the core metal 2 whose surface was provided with the bonding layer was inserted into the hollow space of the hollow cylindrical mold 6. Foamable Si rubber (balloon rubber) (X34-2061-28L, made by Shin-Etsu Chemical Co.) was injected into the space between the surface layer 5 and the core metal 2. The primary vulcanization was performed at 160° C. for 15 minutes including the temperature-rising period. Thus, the elastic layer 3 having a thickness of 1.5 mm was formed.

In this example, also, the PFA dispersion had a surfactant content of at most 5 wt % and at least 1 wt % without containing a film-thickening agent and a viscosity-increasing agent. Consequently, as with Example 1, it was confirmed that there were no residual substances adhering to the hollow cylindrical mold.

In addition, the thickness of each of the first and second surface layers was decreased to a thickness as thin as 6 μm, so that even though the surface layer had a double-layer structure, the total thickness of the surface layer was decreased to a thickness as thin as 12 μm. As a result, it was possible to produce an OA apparatus roller that had good softness in the layers on the core metal, that had excellent parting ability, and that was free from the deterioration of the elastic layer.

Furthermore, the surface layer was composed of two layers, in which the second surface layer was composed of fluororesin containing an SiC filler that is effective in improving the thermal conductivity and wear resistance. As a result, it was possible to produce an OA apparatus roller that had far superior thermal conductivity and durability.

### Example 5

Example 5 is an example in which the thermal conductivity is improved. More specifically, in this example, the thermal conductivity is improved by providing an intermediate layer composed of highly heat-conductive Si rubber. Example 5 has the same structure as that of Example 4, except for the providing of an intermediate layer. Consequently, as for the production process for the OA apparatus roller in Example 5, only the formation of the intermediate layer is described below.

Formation of the Intermediate Layer

After the inner surface of the second surface layer 5b was plasma-treated, a liquid in which highly heat-conductive Si rubber (X32-2020, made by Shin-Etsu Chemical Co.) was diluted with toluene was applied (by flow coating) onto the inner circumferential surface of the second surface layer 5b. The hollow cylindrical mold 6 was revolved around its own axis for 15 minutes at 120° C. to perform the drying. Thus, the intermediate layer 4 having a thickness of 100 μm was formed.

In this example, also, the PFA dispersion had a surfactant content of at most 5 wt % and at least 1 wt % without containing a film-thickening agent and a viscosity-increasing agent. Consequently, as with Example 1, it was confirmed that there were no residual substances adhering to the hollow cylindrical mold.

In addition, the thickness of each of the first and second surface layers was decreased to a thickness as thin as 6 μm, so that even though the surface layer had a double-layer structure, the total thickness of the surface layer was decreased to a thickness as thin as 12 μm. As a result, it was possible to produce an OA apparatus roller that had good softness in the layers on the core metal, that had excellent parting ability, and that was free from the deterioration of the elastic layer.

Furthermore, the second surface layer was composed of fluororesin containing an SiC filler that had excellent thermal conductivity and wear resistance. In addition, the intermediate layer composed of highly heat-conductive Si rubber was also provided. As a result, it was possible to produce an OA apparatus roller that had far superior thermal conductivity and excellent durability.

Table I summarizes the production conditions of the above-described examples and the evaluation results of the OA apparatus rollers produced in the individual examples.

TABLE I

| | | | | | | Example 3 |
|---|---|---|---|---|---|---|
| | | | | Example 1 | Example 2 | Surface layer: |
| | | | | Surface layer: | Surface layer: | single layer, |
| Specification | | | | single layer | double layers | Electroconductive |
| Hollow cylindrical mold | | Inner diameter (mm) | | 18 | 18 | 12 |
| | | Length (mm) | | 257 | 257 | 257 |
| | | Material | | SUS | SUS | SUS |
| Surface | First surface | Dispersion | Type | EMX-047 | EMX-047 | EMX-054-3 |
| layer | layer | | Resin | PFA | PFA | Electroconductive |
| | | | | | | PFA |
| | | | Filler | Not used | Not used | Carbon 2 wt % |
| | | | | | | (content in |
| | | | | | | baked film) |
| | | | Maker | Du Pont Co. | Du Pont Co. | Du Pont Co. |
| | | Thickness (μm) | | 8 | 6 | 8 |
| | | Drying | Temperature | Room | Room | Room |
| | | | | temperature | temperature | temperature |
| | | | Time (Minute) | 10 | 10 | 10 |
| | | | Method | Revolution | Revolution | Revolution |
| | | Baking | Temperature (° C.) | 400 | 400 | 400 |
| | | | Time (Minute) | 30 | 30 | 30 |
| | Second surface | Dispersion | Type | Not formed | EMX-047 | Not formed |
| | layer | | Filler | | Not used | |
| | | | Maker | | Du Pont Co. | |
| | | Thickness (μm) | | | 6 | |
| | | Drying | Temperature | | Room | |
| | | | | | temperature | |
| | | | Time (Minute) | | 10 | |
| | | | Method | | Revolution | |
| | | Baking | Temperature (° C.) | | 400 | |
| | | | Time (Minute) | | 30 | |
| Inner | Bonding layer | Material | Type | DY39-051 | DY39-051 | Not formed |
| circumferential | | | Maker | Dow Corning | Dow Corning | |
| surface | | | | Toray Co. | Toray Co. | |
| of surface | | Thickness (μm) | | 1 or less | 1 or less | |
| layer | Intermediate | Material | Type | Not formed | Not formed | XE16-B7702 |
| | layer | | Material | | | One-liquid-type |
| | | | | | | electroconductive |
| | | | | | | Si rubber |
| | | | Maker | | | Momentive Co. |
| | | | | | | (ex-Toshiba |
| | | | | | | Silicon Co.) |
| | | Thickness (μm) | | | | 4 |
| | Bonding layer | Drying | Temperature (° C.) | 120 | 120 | 120 |
| | and intermediate | | Time (Minute) | 15 | 15 | 15 |
| | layer | | Method | Revolution | Revolution | Revolution |
| Elastic layer | | Material | Type | X34-2061-28L | X34-2061-28L | X34-2869 |
| | | | Material | Si balloon rubber | Si balloon rubber | Electroconductive |
| | | | | | | Si rubber |
| | | | Maker | Shin-Etsu | Shin-Etsu | Shin-Etsu |
| | | | | Chemical Co. | Chemical Co. | Chemical Co. |
| | | Thickness (μm) | | 3.5 | 3.5 | 3 |
| | | Primary | Temperature (° C.) | 160 | 160 | 160 |
| | | vulcanization | Time (Minute) | 15 | 15 | 15 |
| | | Secondary | Temperature (° C.) | 250 | 250 | 250 |
| | | vulcanization | Time (Minute) | 30 | 30 | 30 |
| Surface of | Bonding layer | Material | Type | DY39-051 | DY39-051 | DY39-051 |
| core metal | | | Maker | Dow Corning | Dow Corning | Dow Corning |
| | | | | Toray Co. | Toray Co. | Toray Co. |
| | | Thickness (μm) | | 1 or less | 1 or less | 1 or less |
| | | | | | | (electroconductive) |
| | | Drying | Temperature (° C.) | 120 | 120 | 120 |
| | | | Time (Minute) | 15 | 15 | 15 |

| Core metal | Diameter (mm) | 11 | 11 | 6 |
|---|---|---|---|---|
| | Material | Iron | Iron | Iron |
| Evaluation result | Application | Pressing roller | Pressing roller | Charging roller |
| of produced roller | Special feature | Surface layer having | Surface layer having | Surface layer having |
| | | softness, Surface | softness, Surface | softness, Surface |
| | | layer having parting | layer having parting | layer having parting |
| | | ability | ability | ability, Electroconductive |
| | Picture quality | Satisfactory | Satisfactory | Satisfactory |

| | | | | Example 4 | Example 5 |
|---|---|---|---|---|---|
| | | | | Surface layer: | Surface layer: |
| | | | | double layers, | double layers |
| | | | | Durable, Highly | Durable, Highly |
| Specification | | | | heat-conductive | heat-conductive |
| Hollow cylindrical mold | | Inner diameter (mm) | | 14 | 14 |
| | | Length (mm) | | 257 | 257 |
| | | Material | | SUS | SUS |
| Surface | First surface | Dispersion | Type | EMX-047 | EMX-047 |
| layer | layer | | Resin | Electroconductive | Electroconductive |
| | | | | PFA | PFA |
| | | | Filler | Not used | Not used |
| | | | Maker | Du Pont Co. | Du Pont Co. |
| | | Thickness (μm) | | 6 | 6 |
| | | Drying | Temperature | Room | Room |
| | | | | temperature | temperature |
| | | | Time (Minute) | 10 | 10 |
| | | | Method | Revolution | Revolution |
| | | Baking | Temperature (° C.) | 400 | 400 |
| | | | Time (Minute) | 30 | 30 |
| | Second surface | Dispersion | Type | EMX-041-2 | EMX-041-2 |
| | layer | | Filler | SiC 14.5 vol % | SiC 14.5 vol % |
| | | | | (content in | (content in |
| | | | | baked film) | baked film) |
| | | | Maker | Du Pont Co. | Du Pont Co. |
| | | Thickness (μm) | | 6 | 6 |
| | | Drying | Temperature | Room | Room |
| | | | | temperature | temperature |
| | | | Time (Minute) | 10 | 10 |
| | | | Method | Revolution | Revolution |
| | | Baking | Temperature (° C.) | 400 | 400 |
| | | | Time (Minute) | 30 | 30 |
| Inner | Bonding layer | Material | Type | DY39-051 | |
| circumferential | | | Maker | Dow Corning | Not formed |
| surface | | | | Toray Co. | |
| of surface | | Thickness (μm) | | 1 or less | |
| layer | Intermediate | Material | Type | Not formed | X32-2020 |
| | layer | | Material | | Highly heat- |
| | | | | | conductive Si |
| | | | | | rubber (diluted |
| | | | | | with toluene) |
| | | | Maker | | Shin-Etsu |
| | | | | | Chemical Co. |
| | | Thickness (μm) | | | 100 |
| | Bonding layer | Drying | Temperature (° C.) | 120 | 120 |
| | and intermediate | | Time (Minute) | 15 | 15 |
| | layer | | Method | Revolution | Revolution |
| Elastic layer | | Material | Type | X34-2061-28L | X34-2061-28L |
| | | | Material | Si balloon rubber | Si balloon rubber |
| | | | Maker | Shin-Etsu | Shin-Etsu |
| | | | | Chemical Co. | Chemical Co. |
| | | Thickness (μm) | | 1.5 | 1.5 |
| | | Primary | Temperature (° C.) | 160 | 160 |
| | | vulcanization | Time (Minute) | 15 | 15 |
| | | Secondary | Temperature (° C.) | 250 | 250 |
| | | vulcanization | Time (Minute) | 30 | 30 |
| Surface of | Bonding layer | Material | Type | DY39-051 | DY39-051 |
| core metal | | | Maker | Dow Corning | Dow Corning |
| | | | | Toray Co. | Toray Co. |
| | | Thickness (μm) | | 1 or less | 1 or less |
| | | Drying | Temperature (° C.) | 120 | 120 |
| | | | Time (Minute) | 15 | 15 |

| Core metal | Diameter (mm) | 11 | 11 |
|---|---|---|---|
| | Material | Iron | Iron |
| Evaluation result | Application | — | — |
| of produced roller | Special feature | Surface layer having | Surface layer having |
| | | softness, Surface | softness, Surface |
| | | layer having parting | layer having parting |
| | | ability, Heat | ability, Heat |
| | | conductive, Durable | conductive, Durable |
| | Picture quality | — | — |

What is claimed is:

1. A method of producing an OA apparatus roller, the method comprising a step of forming an elastic layer and a surface layer in this order on a core metal;
wherein:
(a) the surface layer is formed by using a fluororesin dispersion; and
(b) the fluororesin dispersion contains a surfactant, a film-thickening agent, and a viscosity-increasing agent with a total content of 1.0 to 5.0 wt %.

2. The method of producing an OA apparatus roller as defined by claim 1, wherein the fluororesin dispersion has a film-thickening-agent content of at most 1 wt % and a viscosity-increasing-agent content of at most 1 wt %.

3. The method of producing an OA apparatus roller as defined by claim 2, wherein the fluororesin dispersion contains practically no film-thickening and viscosity-increasing agents.

4. The method of producing an OA apparatus roller as defined by claim 1, wherein the fluororesin dispersion for forming the surface layer has a fluororesin constituent that is composed of at least one member selected from the group consisting of PFA, PTFE, and FEP.

5. The method of producing an OA apparatus roller as defined by claim 1, wherein the surface layer is composed of a single fluororesin layer having a thickness of 3 to 15 μm.

6. The method of producing an OA apparatus roller as defined by claim 1, wherein:
(a) the surface layer is composed of a plurality of fluororesin layers;
(b) each of the fluororesin layers has a thickness of 3 to 15 μm; and
(c) the surface layer has a total thickness of 6 to 30 μm.

7. The method of producing an OA apparatus roller as defined by claim 1, wherein:
(a) the surface layer is formed by applying the fluororesin dispersion onto the inner surface of a hollow cylindrical mold and then by performing a baking operation;
(b) the elastic layer is formed by inserting the core metal into the hollow space of the hollow cylindrical mold and then by injecting a material for forming the elastic layer into the space between the surface layer and the core metal; and
(c) the OA apparatus roller in which the elastic layer and the surface layer are formed on the core metal is drawn out of the hollow cylindrical mold.

8. The OA apparatus roller produced by the method of producing an OA apparatus roller as defined by claim 1.

9. The OA apparatus roller produced by the method of producing an OA apparatus roller as defined by claim 2.

10. The OA apparatus roller produced by the method of producing an OA apparatus roller as defined by claim 3.

11. The OA apparatus roller produced by the method of producing an OA apparatus roller as defined by claim 4.

12. The OA apparatus roller produced by the method of producing an OA apparatus roller as defined by claim 5.

13. The OA apparatus roller produced by the method of producing an OA apparatus roller as defined by claim 6.

14. The OA apparatus roller produced by the method of producing an OA apparatus roller as defined by claim 7.
